(19) United States
(12) Patent Application Publication
(10) Pub. No.: US 2023/0087694 A1
(43) Pub. Date: Mar. 23, 2023

(54) METHOD OF CONTROLLING ELECTRONICALLY CONTROLLED FUEL INJECTION DEVICE

(71) Applicant: ZAMA JAPAN KABUSHIKI KAISHA, Iwate (JP)

(72) Inventors: Hiroo Ubukata, Iwate (JP); Toshinobu Shimoyama, Iwate (JP)

(21) Appl. No.: 17/889,532

(22) Filed: Aug. 17, 2022

(30) Foreign Application Priority Data
Aug. 23, 2021 (JP) 2021-105904

(51) Int. Cl. F02M 51/06; F02M 37/00; F02M 61/20

(52) U.S. Cl. CPC F02M 51/0625; F02M 37/0052; F02M 61/20

(57) ABSTRACT

A method to prevent generation of impact noise caused by an armature contacting a stopper due to a return spring and damage of the armature and a stopper without adding a part. Excitation of an electromagnetic coil 4 causes an armature 9 at a standby position to move in a plunger 7 direction so as to move the plunger 7 inserted in a pressurizing chamber 3 in a tip end direction against a return spring 8 to a level such that fuel is not injected from an injection nozzle 2. Fuel supplied from a fuel tank to the pressurizing chamber 3 through a fuel intake pipe 10 and inlet check valve 11 is pressurized and vapor included in the fuel inside the pressurizing chamber 3 is discharged to a fuel return pipeline 14 through a spill valve 12 and return passage 13. Excitation of the electromagnetic coil 4 is stopped, and then the electromagnetic coil 4 is re-excited prior to the armature 9 and plunger 7 reaching the standby position due to the return spring 8, such that the return speed of the armature 9 is reduced and an impact when the armature 9 contacts a stopper 15 is mitigated.

### CROSS-REFERENCE TO RELATED APPLICATION

The subject application claims the benefit of Japanese Patent Application No. 2021-105904, filed Aug. 23, 2021, which is incorporated herein by reference in its entirety.

### FIELD

The present invention relates to a method of controlling an electronically controlled fuel injection device that uses a reciprocating plunger to pump and inject fuel supplied to a pressurizing chamber through an injection nozzle and into an air intake port of an engine.

CONVENTIONAL TECHNOLOGY

Conventionally, for example, Japanese Unexamined Patent Application 2007-263016 proposes an electronically controlled fuel injection device in which fuel is pumped and injected using pump action of an electromagnetically driven plunger through an injection nozzle and into an air intake port of an engine.

In a conventional electronically controlled fuel injection device as illustrated in FIG. 1, a pair of inner yokes 6, 6 arranged vertically as illustrated in the drawing are connected via a spacer 61 in between. The inner yokes 6,6 being arranged inside a cylindrical bobbin 5 with an inner circumferential surface that is larger in diameter in a base end direction of a pressurizing chamber 3 than the cylindrical pressurizing chamber 3. The cylindrical pressurizing chamber 3 is provided with an injection valve 1 and an injection nozzle 2 facing an engine air intake port (not shown) in a tip end direction. An electromagnetic coil 4 is formed by winding an electric wire around an outer circumference of the cylindrical bobbin 5. An armature 9, which is fitted and arranged to reciprocate in an axial direction within the inner yokes 6, 6 and operating in conjunction with a plunger 7 fitted and arranged to reciprocate in the axial direction in the pressurizing chamber 3 in a tip end direction thereof, is normally in a prescribed standby position in the axial direction in a state contacting a stopper 15 due to a return spring 8 that is biased toward the base end direction. Excitation of the electromagnetic coil 4 moves the armature 9 in the tip end direction against the return spring 8 and moves the plunger 7 in the tip end direction. As a result, fuel supplied from a fuel tank (not shown) to the pressurizing chamber 3 via a fuel intake pipe 10 and inlet check valve 11, is pressurized and injected from the injection nozzle 2 via the injection valve 1 into an engine (not shown). Excitation of the electromagnetic coil 4 is stopped such that the plunger 7 integrated with the armature 9 is moved in the base end direction by the biasing force of the return spring 8. Then, the operation of supplying fuel to the pressurizing chamber 3 is again repeated.

Furthermore, a conventional electronically controlled fuel injection device includes a fuel pump and the injection valve 1 are integrated with the plunger 7 driven by the electromagnetic coil 4, and a fuel pump portion also functions as a pressure regulator. In a conventional electronically controlled fuel injection device of this type, vapor occurs in the fuel due to the pressure loss generated when the fuel is supplied to the pressurizing chamber 3 through the inlet check valve 11.

Therefore, the vapor produced when supplying the fuel, including vapor naturally flowing in the fuel, is sent through a spill valve 12 to a return passage 13. The spill valve 12 is provided in the pressurizing chamber 3 and regulates discharged fuel. The return passage 13 is formed between an outer surface of the inner yoke 6 surrounding the armature 9 and an inner wall surface of the bobbin 5. The electromagnetic coil 4 is arranged and wound on an outer periphery the bobbin 5. Furthermore, as illustrated in FIG. 2, a portion of the fuel supplied to the pressurizing chamber 3 through a cutout window 62 formed in the upper inner yoke 6 and in connection with the return passage 13, is returned to the fuel tank (not shown) through a fuel return pipeline 14 provided in a head cap 63 placed, as illustrated, on an upper portion of the fuel injection device.

However, in this type of electronically controlled fuel injection device, even after the engine has been stopped, the inside of the pressurizing chamber 3 is filled with a large amount of vapor due to exposure to high temperatures from heat transferred from the engine. This is one factor that prevents the engine from starting when the engine is restarted after stopping.

Therefore, when an engine is difficult to restart due to the pressurizing chamber 3 being filled with a large amount of vapor after the engine is stopped, before opening the injection valve 1 and starting the engine, a current is applied to the electromagnetic coil 4 to drive the armature 9 (plunger 7) to a level such that fuel is not injected from the injection nozzle 2 and vapor included in the fuel in the pressurizing chamber 3 is discharged from the spill valve 12 to the fuel return pipe 14 through the return passage 13. The engine is easily restarted as a result.

However, FIG. 4 is a state diagram illustrating chronological current control to an electromagnetic coil 4 and the state of oscillation of the electronically controlled fuel injection device at that time for a method of control prior to restarting enabling simple restarting. First, a pulse current (I1) is applied to the electromagnetic coil 4 illustrated in FIG. 1 beyond a time (T1) to drive the armature 9 (plunger 7) to a level where fuel is not injected from the injection nozzle 2. After vapor included in the fuel in the pressurizing chamber 3 is discharged from the spill valve 12 through the return passage 13 to the fuel return pipeline 14, and the injection pulse current (I1) is stopped, the armature 9 (plunger 7) is returned in the base end direction by the return spring 8 to the original standby position at which point the armature 9 impacts the stopper 15 causing vibration.

At this time, the engine is still in a stopped and quiet state, and the oscillation is transmitted to the outside as a driving sound. However, the impacting armature 9 is formed of a hard, magnetic metal, and the stopper 15 is formed by a hard synthetic resin or the like. Therefore, the driving sound (oscillation) generated when the armature 9 and stopper 15 collide causes discomfort to a user. Furthermore, there is a problem where the mutually colliding armature 9 and stopper 15 are formed of hard materials and are easily damaged. In particular, in many cases, it is difficult to drive the armature 9 (plunger 7) one time to a level enabling discharging the vapor included in the fuel in the pressurizing chamber 3 by applying a current to drive the armature 9 (plunger 7) yet not discharging fuel from the injection nozzle 2, inevitably resulting in a reciprocating movement of the armature 9 (plunger 7) a plurality of times, which aggravates the problem.

Furthermore, Japanese Unexamined Patent Application S55-35135, for example, proposes this type of electronically controlled fuel injection device b3 provided with an impact absorbing body, such as rubber material or the like, as means of preventing wear and tear due to contact between the armature 9 and stopper 15. However, adding a separate part has a problem of not only complicating the manufacturing process, including parts management, but also causing the impact absorbing body to deteriorate or be damaged by use, requiring maintenance and repair.

### SUMMARY

The present example embodiments, which resolve the issues in the an electronically controlled fuel injection device described above, provide a control method for when restarting an engine is difficult due to a pressurizing chamber being filled with a large amount of vapor after stopping the engine. The method includes preventing or reducing impact noise generation and armature and stopper damage, which are caused by an armature contacting a stopper due to a return spring when vapor included in fuel inside the pressurizing chamber is discharged to a fuel return pipe through a spill valve and return passage by applying a current to an electromagnetic coil to drive a plunger to a level that fuel is not injected from an injection nozzle, without adding a part.

In order to solve the problem, the present example embodiments include a method for controlling an electronically controlled fuel injection device, including: causing reciprocating motion of a plunger that is normally at a standby position in contact with a stopper based on a return spring and controlling fuel that can be injected into a pressurizing chamber using an armature that moves by means of excitation of an electromagnetic coil to pressurize fuel supplied to the pressurizing chamber and inject the fuel through an injection nozzle into an engine, and discharging vapor mixed into fuel by returning a part of the fuel supplied to the pressurizing chamber via a return passage, through a fuel return pipe, to a fuel tank, wherein excitation of the electromagnetic coil causes the armature in the standby position to move in the plunger direction and the plunger is caused to move in the tip direction against the return spring into the pressurizing chamber to a level that does not cause fuel to be injected from the injection nozzle. After discharging vapor included in the fuel supplied to the pressurizing chamber and pressurized to a fuel return pipe, excitation of the electromagnetic coil is stopped. The electromagnetic coil is then re-excited before the return spring causes the armature and plunger to reach the standby position, reducing the return speed of the armature and mitigating the impact when the armature contacts the stopper and also reduces noise.

Furthermore, in the present example embodiments, determination of an excitation time and excitation period of the re-excitation are based on a biasing force of the return spring for pushing the armature and plunger back to a prescribed standby position, such that the effect of re-excitation is reliably exhibited, and no wasteful power is required.

The method of controlling an electronically controlled fuel injection device of the present example embodiments when restarting an engine is difficult due to a pressurizing chamber being filled with a large amount of vapor after stopping the engine, can, without adding a part, prevent impact noise generation and armature and stopper damage that are caused by an armature contacting a stopper due to a return spring when vapor included in fuel inside the pressurizing chamber is discharged to a fuel return pipe through a spill valve and return passage by applying current to an electromagnetic coil to drive a plunger to a level such that fuel is not injected from an injection nozzle.

Other systems, devices, methods, features and advantages of the subject matter described herein will be or will become apparent to one with skill in the art upon examination of the following figures and detailed description. It is intended that all such additional systems, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWINGS

The accompanying drawings, which are included as part of the present specification, illustrate the presently example embodiments and, together with the general description given above and the detailed description of the example embodiments given below, serve to explain and teach the principles of the present invention.

FIG. 1 is a front vertical cross-sectional view illustrating an electronic fuel injection device used in a preferred embodiment of the present example embodiments and in a conventional example.

FIG. 2 is a front vertical cross-sectional view illustrating a cutout of an electronic fuel injection device of the embodiment illustrated in FIG. 1.

FIG. 3 is a state diagram illustrating chronological current control to an electromagnetic coil at the time of restart in a method of controlling an electromagnetic fuel injection device of the present example embodiments and the oscillation state in the electronic fuel injection device at this time.

FIG. 4 is a state diagram illustrating chronological current control to an electromagnetic coil at the time of restart in a method of controlling an electromagnetic fuel injection device of the conventional example and the oscillation state in the electronic fuel injection device at this time.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DESCRIPTION OF THE EXAMPLE EMBODIMENTS

An example embodiment of an electronically controlled fuel injection device of the present example embodiments will be described in detail below based on the drawings.

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Representative examples of the embodiments described herein, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter. An example embodiment of an electronically controlled fuel injection device of the present invention will be described in detail below based on the drawings.

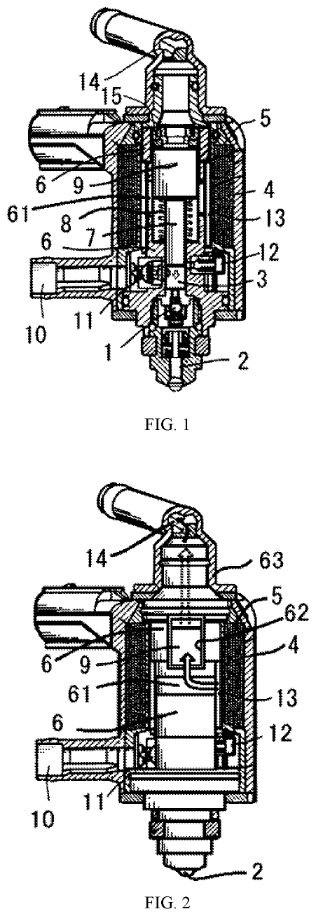

FIG. 1 illustrates an example of an electronically controlled fuel injection device used in implementing the method of controlling the electronically controlled fuel injection device of the present example embodiments. The structure itself and operating conditions of fuel injection are the same as those indicated in the conventional example above, and thus a detailed description will be omitted.

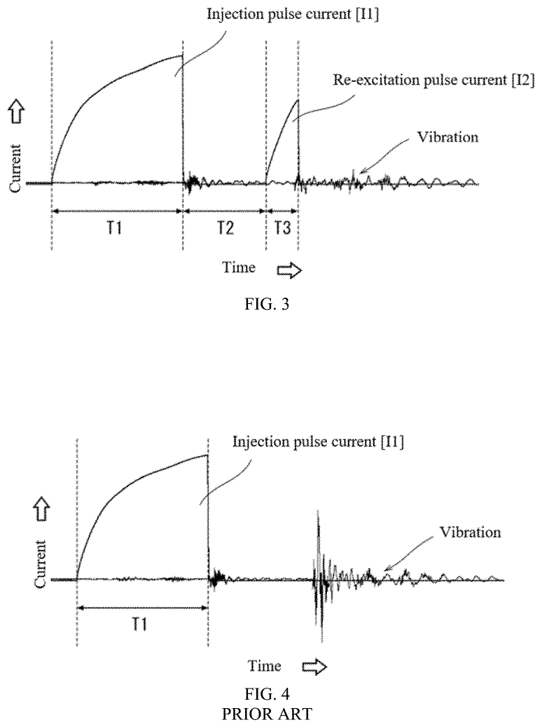

Next, the state diagram of FIG. 3 will be further described, which chronologically shows current control to an electromagnetic coil at the time of engine restart in the method of controlling an electromagnetic fuel injection device of the present example embodiments and an oscillation state of the electronic fuel injection device at this time. When starting an engine in a state with vapor mixed in the pressurizing chamber 3, and when the armature 9 (plunger 7) is reciprocated to discharge vapor included in fuel inside the pressurizing chamber 3 to the fuel return pipe 14 through the spill valve 12 and return passage 13 to a level that fuel is not injected from the injection nozzle 2, as in the case of the conventional example shown in FIG. 4, the pulse current (I1) is applied to excite the electromagnetic coil 4 for only time (T1) to move the armature 9, which is in the standby position due to the return spring 8 in the plunger 7 direction, and move the plunger 7, which is inserted in the pressurizing chamber 3 in the tip end direction against the return spring 8 to a level that fuel is not injected from the injection nozzle 2. The fuel supplied from a fuel tank (not shown) to the pressurizing chamber 3 via the fuel intake pipe 10 and inlet check valve 11 is pressurized to discharge the vapor included in the fuel in the pressurizing chamber 3 from the spill valve 12 to the fuel return pipe 14 via the return passage 13, and then excitation of the electromagnetic coil 4 is stopped.

Here, in the conventional example above, as shown in FIG. 4, when the current (I1) of the injection pulse is stopped, oscillation of the armature 9 (plunger 7) was generated when being pushed in the base end direction by the return spring 8 to return to the original standby position in contact with the stopper 15, and causing the armature 9 to impact the stopper 15. However, in the present example embodiment, before excitation of the electromagnetic coil 4 is stopped and the armature 9 and plunger 7 reach the standby position (position where a base end of the armature 9 contacts the stopper 15) due to the return spring 8, in other words, after a prescribed time (T2) has elapsed after stopping the excitation of the electromagnetic coil 4 illustrated in FIG. 3, a prescribed re-excitation pulse current (I2) is applied to the electromagnetic coil 4 for a prescribed time (T3) to reduce the return speed of the armature 9 against the biasing force of the return spring 8.

As a result, impact when the armature 9 contacts the stopper 15, as in the conventional example shown in FIG. 4, is mitigated, resulting in reduced noise and reduced damage to parts.

In this manner, according to the present Embodiment, when restarting the engine, the armature 9 (plunger 7) is caused to reciprocate to a level that fuel is not injected from the injection nozzle 2 to remove vapor included in the fuel in the pressurizing chamber 3. Vapor included in the fuel in the pressurizing chamber 3 is discharged to the fuel return pipe 14 via the spill valve 12 and return passage 13. The impact when the armature 9 (plunger 7) is returned to the standby position by the return spring 8 thereafter can be prevented. This prevents imparting an unpleasant noise to the user and simplifies restarting the engine when there is fuel containing vapor in the pressurizing chamber 3. Furthermore, no maintenance or repair is required for damaged parts, as impact similar to that in the conventional example is not present.

In addition, the method of controlling an electronic fuel injection device of the present embodiment does not require the attachment of a part such as a non-impact member to the stopper 15 or armature 9 as was conventionally required. The method of the present example embodiments is simply to perform electrical control in which the prescribed re-excitation pulse current (I2) is applied to the electromagnetic coil 4 for a prescribed time (T3) after a prescribed time (T2) has elapsed after excitation of the electromagnetic coil 4 is stopped, and can be easily applied to an existing electronic fuel injection device without complicating parts management and assembly.

Furthermore, the re-excitation time (T3) and excitation period (T1+T2) shown in FIG. 3 are calculated and determined based on the biasing force of the return spring 8 for returning the armature 9 and plunger 7 back to the prescribed standby position, such that the effect of re-excitation is reliably exhibited, and no wasteful power is required.

Note that the present embodiment relates to control for reciprocating the armature 9 (plunger 7) to discharge vapor included in fuel inside the pressurizing chamber 3 to the fuel return pipe 14 through the spill valve 12 and return passage 13 to a level that fuel is not injected from the injection nozzle 2 when starting the engine in a condition where the vapor is mixed in the pressurizing chamber 3. Control is easy because the present embodiment is applied when the reciprocating motion of the armature 9 (plunger 7) is relatively slow. However, it goes without saying that this also applies to normal engine operation.

Description of Referential Numerals and Codes: 1: Injection valve, 2: Injection nozzle, 3: Pressurizing chamber, 4: Electromagnetic coil, 5: Bobbin, 6: Inner yoke, 7: Plunger, 8: Return spring, 9: Armature, 10: Fuel intake pipe, 11: Inlet check valve, 12: Spill valve, 13: Return passage, 14: Fuel return pipe, 15: Stopper, 61: Spacer, 62: Cutout window, 63: Head cover

What is claimed is:

1. A method for controlling an electronically controlled fuel injection device, comprising:
causing reciprocating motion of a plunger that is normally at a standby position in contact with a stopper based on a return spring and controlling fuel that can be injected into a pressurizing chamber using an armature that moves by means of excitation of an electromagnetic coil to pressurize fuel supplied to the pressurizing chamber and inject the fuel through an injection nozzle into an engine, and
discharging vapor mixed into fuel by returning a part of the fuel supplied to the pressurizing chamber via a return passage, through a fuel return pipe, to a fuel tank,
wherein when starting the engine, excitation of the electromagnetic coil causes the armature in the standby position to move in the plunger direction and the plunger is caused to move against the return spring into the pressurizing chamber to a level that does not cause fuel to be injected from the injection nozzle in the tip direction, and after discharging vapor included in the fuel supplied to the pressurizing chamber and pressurized to a fuel return pipe, excitation of the electromagnetic coil is stopped, and then the electromagnetic coil is re-excited before the return spring causes the armature and plunger to reach the standby position, reducing the return speed of the armature and mitigating the impact and reducing noise when the armature contacts the stopper.

2. The method of controlling an electronically controlled fuel injection device according to claim 1, wherein an excitation time and excitation period of the re-excitation are determined based on the biasing force of the return spring for returning the armature and plunger to a prescribed standby position.
